(19) United States
(12) Patent Application Publication
(10) Pub. No.: US 2021/0208763 A1
(43) Pub. Date: Jul. 8, 2021

(54) REMOTE INTERACTIVE SYSTEM OF AUGMENTED REALITY AND ASSOCIATED METHOD

(71) Applicant: TYCOON PROMOTION SAGL, Lugano (CH)

(72) Inventor: Maurizio NAGGIAR, Lugano (CH)

(21) Appl. No.: 16/071,437

(22) PCT Filed: Jan. 19, 2016
(86) PCT No.: PCT/IB2016/050250

§ 371 Date: Jul. 19, 2018

(51) Int. Cl. G06F 3/0481; G06F 3/01; G06F 3/0482; G06F 3/0346; G06Q 30/06

(52) U.S. Cl. CPC G06F 3/04815; G06F 3/012; G06Q 30/0641; G06F 3/0346; G06F 3/0482

(57) ABSTRACT

Electronic system (100) of interaction between a user (300) and a tridimensional virtual space (200), comprising means of creation of a virtual tridimensional space within the quale said user can move and/or move the point of vision of a virtual subject (230), means of definition and motion of a point of vision (K) of said virtual subject (200) within said virtual tridimensional space (200), and comprising furthermore:
at least one computer or electronic device or server or computer network (110) wherein said tridimensional space (200) is created and stored;
at least one user interface electronic device (140), transceiving at least electronic data of motion of said point of vision (K) with said at least one computer or electronic device or server or computer network (110).

### FIELD OF THE TECHNIQUE

The present invention refers to the field augmented reality, and in detail concerns a remote interactive system of augmented reality.

the present invention concerns furthermore an interactive method of augmented reality between two remote devices.

### BACKGROUND ART

It is well known the use of devices of augmented reality that though electronic devices worn by the user are capable of making thus user move in a tridimensional virtual space. The tridimensional virtual space is typically defined basing on a tridimensional space.

The Applicant has often noticed that today, always characterized by a greater shortage of times in which people can meet in shops and the time necessary to go shopping is always more limited. There are online shops, typically accessible through a web browser wherein the user can perform purchases by clicking on one or more images of products.

The Applicant has noticed that the virtual shops present a degree of APPETIBILITA by an aesthetic and emotional point of view on the client extremely limited, since their APPETIBILITA is increasable only in function of the aesthetic aspect of the site. In other words, all the virtual shops present the drawback of not offering to the user an actual area within which he can move and perform purchases.

Nonetheless, in case two people knowing each other perform simultaneously a purchase in the same virtual mall, they will meet, that is none of those two will know in real time if the other person is performing the same purchase. We can therefore say more in general that is therefore possible to affirm that in today's system and real shops the online purchases or virtual shops there is no possibility of creating a social environment of interaction among more users, suitable of rendering really APPETIBILE the purchase of a product.

The scope of the present invention is therefore to describe an interactive remote system of augmented virtual reality that allows to solve the aforementioned drawbacks.

A second scope of the present invention is to describe a method of interaction in augmented reality between two remote devices which allows to solve the aforementioned drawbacks.

### SUMMARY OF THE INVENTION

The present invention is targeted to describe a method and a remote interactive system of augmented reality which allows the most possible emotional and realistic interaction of a user in a tridimensional virtual space or shop wherein it is possible to perform purchases as well as meet with other people that in truth are remotely positioned respective to the user in the real environment but find themselves in the same circumscribed virtual environment under the form of virtual figure or avatar.

though the present invention, it is further possible to perform purchases in an easier way respective to that happens with the traditional virtual shops, since the user can see tridimensional the objects, and can move himself and perform a purchase exactly as it would be if it would be in a real shop or in a supermarket, that is to say though a rototrasnlational motion of at least the head within said tridimensional virtual space.

To the end of reaching the aforementioned objects, with the present invention is realized an electronic system of interaction between a user and a tridimensional virtual space, comprising means of creation of a virtual tridimensional space within which said user can move and/or move the point of vision of a virtual subject, means of definition and motion of a point of vision of said virtual subject within said virtual tridimensional space, and further comprising:
at least one computer or electronic device or server or computer network wherein said tridimensional space is created and stored;
at least one user interface electronic device, transceiving at least electronic data of motion of said point of vision with said at least one computer or electronic device or server or computer network wherein said user interface electronic device comprises means of visualization of said virtual tridimensional space and represents on said means of visualization of said virtual tridimensional space a variation in real time of said point of vision;
   wherein in said virtual tridimensional space, said computer or electronic device or server or computer network stores a plurality of objects defined on a plurality of points respective to a reference system own of said virtual tridimensional space;
   and wherein said means of definition and motion of said point of vision store on said at least one computer or electronic device or server or computer network a variation or adaptation of a status of the at least one of said plurality of objects according to a selection or adaptation command of at least one object of said plurality of objects performed by said user by means of said at least one user interface electronic device, and transmit towards said at least one user interface electronic device, an adaptation code of said status of said selected object, wherein said adaptation code of said status causes a variation of the operation of said at least one user interface electronic device.

In detail said computer or electronic device or server or computer network are configured for providing in streaming, that is to say in real time, the electronic data that allow to show said tridimensional space on an at least one external electronic device.

According to an aspect of a preferred embodiment of the present invention, said plurality of objects is a plurality of usable products, wherein for each purchasable product on said at least one computer or electronic device or server or computer network is stored at least one adaptable price data, a residual quantity datum, and wherein at the moment of said selection, means of electronic counting are configured for decreasing said residual quantity datum and store a new residual quantity datum according to said selection performed by said user by means of said at least one user interface electronic device.

According to an aspect of a preferred embodiment of the present invention, said plurality of objects is a plurality of parts of a confined environment, and wherein said status is a datum stored on said at least one computer or electronic device or server or computer network, comprising size data and/or of graphic appearance of said object, and wherein said means of definition and motion of said point of vision, at the moment of the adaptation of said status, transmit data of adaptation of a graphic appearance of said selected object towards said at least one user interface electronic device.

According to an aspect of a preferred embodiment of the present invention, said system is configured so as to that said computer or electronic device or server or computer network transmits automatically towards said user interface electronic device a movie suitable to be perceived by the user as a tridimensional and electronically associated to said at least one selected object, and wherein said user interface electronic device reproduces said tridimensional movie by adapting the point of vision within said tridimensional movie according to motion data of said user interface electronic device respective to a tridimensional reference system own of said user interface electronic device, and wherein said variation of operation of said at least one user interface electronic device comprises a switching of the representation of said virtual tridimensional space to the representation of said tridimensional movie.

More in detail said user interface electronic device reproduces in real time said tridimensional movie.

According to an aspect of a preferred embodiment of the present invention, said point of vision is originated by a tridimensional reference of said virtual user positioned at a known distance respective to a fixed reference system of said virtual tridimensional space, said fixed reference being stored and automatically updated at each movement of said user interface electronic device.

According to an aspect of a preferred embodiment of the present invention, said point of vision is originated from a movable tridimensional reference system within said virtual tridimensional space and wherein said electronic computer or electronic computer network update automatically the distance between said tridimensional movable reference system and said fixed tridimensional reference system, said movable reference being stored and automatically updated at each movement of said user interface electronic device.

According to an aspect of a preferred embodiment of the present invention, said user interface electronic device comprises a plurality of sensors of zenithal and azimuthal motion, said sensors being configured for transmitting on a plurality of time intervals data of motion of said point of vision within said virtual tridimensional space.

According to a further aspect of a preferred embodiment of the present invention, said virtual tridimensional space said computer or electronic device or server or computer network calculates the motion of more virtual subjects simultaneously, each one with an own point of vision controlled by a respective real user provided with a respective user interface electronic device univocally electronically associated with said own virtual user.

According to an aspect of a preferred embodiment of the present invention, said computer or electronic device or server or computer network calculates a communication of an audio and/or video data stream among virtual subjects simultaneously.

According to the present invention it is furthermore described a method of interaction of a user in a virtual tridimensional space, said method comprising:
a step of creation of a virtual tridimensional space inside a memory of a computer or electronic device or server or computer network,
a step of storage in said memory of at least one of a plurality of virtual subjects, susceptible of move themselves and/or adapt an own point of vision of said virtual tridimensional space;
a subsequent step of electronic assigning of each virtual subject of said plurality of virtual subjects to the electronic control by of a respective user interface remote electronic device, wherein said user interface electronic device comprises means of visualization of said virtual tridimensional space and represents on said means of visualization of said virtual tridimensional space a variation in real time of said point of vision;
a step of storage within said virtual tridimensional space of a plurality of objects of which at least part possesses a adaptable electronic status though said user interface remote electronic device and is stored in the memory of said computer or electronic device or server or computer network, and wherein an adaptation code of the electronic status of said object of said plurality of objects is transmitted by said user interface remote electronic device following of a selection of an object by said user controlling the virtual subject through the user interface remote electronic device and causes a variation of the operation of said at least one user interface electronic device.

According to an aspect of a preferred embodiment of the present invention, said adaptable electronic status of said at least one object of said plurality of objects is a price, a residual quantity of products in at least one warehouse, and at the moment of said selection, means of electronic counting perform a step of decrease of a residual quantity of product within said warehouse and store a new residual quantity datum according to said selection performed by said user by means of said at least one user interface remote electronic device.

According to an aspect of a preferred embodiment of the present invention, said plurality of objects comprises at least in part a plurality of parts of a confined environment and wherein said status is a datum stored that comprises size data and/or of graphic appearance of said object, and wherein means of definition and motion of a point of vision of said object, at the moment of the adaptation of said status, transmit data of adaptation of a graphic appearance of said selected object towards said at least one user interface remote electronic device.

According to an aspect of a preferred embodiment of the present invention, each virtual subject of said plurality of virtual subjects comprises a point of vision generated by a tridimensional reference of said virtual user positioned to a known distance respective to a reference system fixed of said virtual tridimensional space; said tridimensional reference system of said virtual user is stored and automatically updated to each motion of said user interface electronic device.

According to an aspect of a preferred embodiment of the present invention, said point of vision is originated from a tridimensional movable reference system within said virtual tridimensional space and wherein said electronic computer or electronic computer network update automatically the distance between said tridimensional reference system fixed and said tridimensional movable reference system, said tridimensional movable reference system being stored and automatically updated to each motion of said user interface electronic device.

According to an aspect of a preferred embodiment of the present invention, said method comprises a transmission on a plurality of intervals of time, data of motion of said point of vision within said virtual tridimensional space, said transmission taking place starting from user interface remote electronic device which comprises a plurality of sensors of motion zenithal and azimuthal.

According to an aspect of a preferred embodiment of the present invention, within said virtual tridimensional space said computer or electronic device or server or computer network calculates the motion of more virtual subjects simultaneously, each one with a own point of vision controlled by a respective real user provided with of a respective user interface electronic device univocally electronically associated with said own virtual user.

According to an aspect of a preferred embodiment of the present invention, said computer or electronic device or server or computer network calculates the a communication of an audio and/or video data stream among a plurality of virtual subjects simultaneously.

According to a further aspect of the present invention, the data transmitted towards said user interface electronic device are preferably transmitted with a low latency, lower than to 1 s. Such a latency, when possible in compatibility with the requirements of the network and/or channel of data transmission, concurs to render the experience of fruition of the tridimensional virtual environment on the user interface electronic device the most possible real and fluid, in particular when a multiplicity of users can simultaneously interact on the same tridimensional virtual environment.

According to a further aspect of the present invention, the data transmitted towards said user interface electronic device are transmitted with channel encoding for the mitigation of burst errors.

### DESCRIPTION OF THE ANNEXED FIGURES

The present invention will be now described in an own preferred embodiment and non-limiting, in which:

FIG. 1 illustrates a tridimensional virtual space, wherein a virtual subject (avatar) orientates its point of vision respective to a system of coordinates of reference;

FIG. 2 illustrates a plurality of user-wearable electronic devices and schematized for reasons of representation in an exchange of data with a computer or electronic device or server or computer network;

FIG. 3 illustrates an action of selection of an object contained in said tridimensional virtual space by of said virtual subject; and

FIG. 4 illustrates a schematic block diagram of representation of a process of selection by of said user.

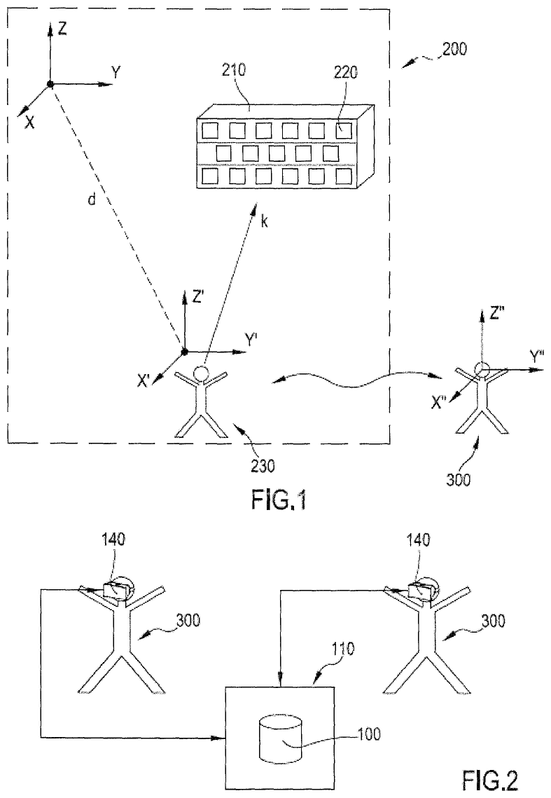

### DETAILED DESCRIPTION OF THE INVENTION

The present invention concerns an electronic system of interaction between a user and a tridimensional virtual space 100. The system 100 comprises at least one electronic server computer 110 or alternatively an electronic computer network electronically connected in such a way of transceiving data one to the other and eventually subdivide among them the working computation load.

Within the electronic server computer 110 is contained at least a memory 120 wherein are stored data defining a tridimensional virtual space 200, of a tridimensional type, defined on a first triad of fixed axes X,Y,Z.

Inside said tridimensional virtual space 200, objects 210, 220 are defined, of which some have parameters which are adaptable according to actions and electronic commands received from a user interface remote electronic device 140 provided to a user 300. The transmission of said electronic commands by said user interface remote electronic device 140 towards the electronic server computer 110 takes place according to a known technique.

As schematically shown in FIG. 1, the objects 210, 220 which are present in the tridimensional virtual space 200 are divided therefore in “fixed” objects, that is to say in objects that can represent for example and in a non-limiting extent furniture, walls, complement furniture in general, and objects 220 which as already stated have the parameters adaptable according to the actions and electronic commands received by said user interface remote electronic device 140.

In detail, each object 210, 220 presents a position defined in the tridimensional virtual space 200, and said position is defined by at least a triad of coordinates (x, y, z) which are centered on said first triad of axes X,Y,Z.

The at least one triad of coordinates (x,y,z) of each object 210, 220 is stored in advance in the memory 120 so as to create a sort of furnished tridimensional virtual space.

In association to each object 210, 220, on the memory 120 is furthermore stored an image of the object itself. Tale image can be either a traditional image of bidimensional type, or a tridimensional image, thus wherein the graphic appearance of the object recalls a photography or model that appears different according to the direction from which the object itself is observed.

Inside the tridimensional virtual space 200, is furthermore created a virtual subject 230, onto which is centered a second triad of axes X′,Y′,Z′. The second triad of axes X′,Y′,Z′ defines a position of the virtual subject 230 and it is also stored in the memory 120.

In a first preferred and non-limiting embodiment of the present invention, the second triad of axes X′,Y′,Z′ is fixed. This means that the virtual subject 230 cannot move inside the tridimensional virtual space 200. Anyway, the virtual subject 230 has a own direction of observation. Technically the direction of observation, represented in FIG. 1 though the line K is defined in accordance for example of a zenithal and azimuthal angle centered on the second triad of axes X′,Y′,Z′. Therefore in absence of objects, the virtual subject 230 points a direction defined by the line K and can “see” an object 210, 220, technically the first object that is positioned at the minimum distance between its position respective to the first triad of axes X,Y,Z, along the line K.

In a second preferred and non-limiting embodiment of the present invention, the second triad of axes X′,Y′,Z′ is movable. Technically this implies that the virtual subject 230 can move inside the tridimensional virtual space 200. Therefore the line K, representing the observation direction of the virtual subject 230, rigidly moves with the position of the second triad of axes X′,Y′,Z′. The position of the second triad of axes X′,Y′,Z′ is therefore no more statically stored in the memory 120. In said second preferred and non-limiting embodiment, said position of the second triad of axes X′,Y′,Z′ respective to the first triad of axes X,Y,Z is updated by means of a new loading in the memory 120 each time the virtual subject 230 is made to move by the user 300 by means of said user interface remote electronic device 140.

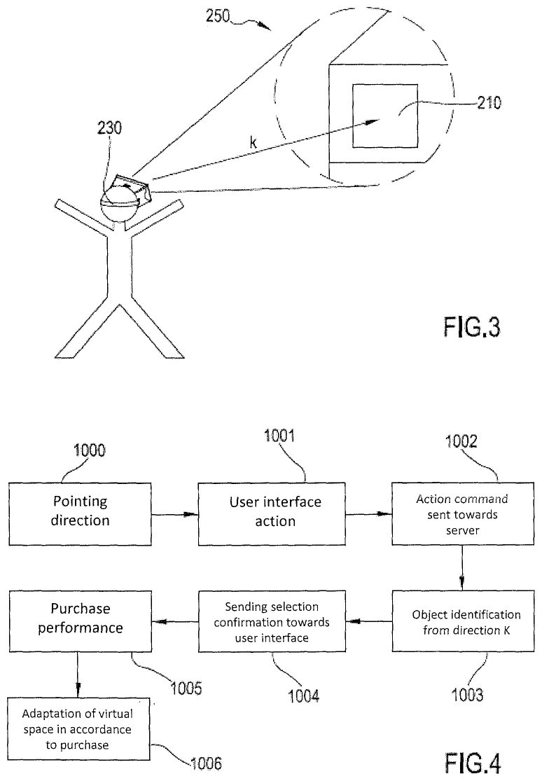

In detail, in the FIG. 3 is shown a virtual subject 230 that points a specific object 210 though the line K.

During the pointing, though the motion of the line K centered on the second triad of axes X′,Y′,Z′, the virtual subject 230 frames an area 250 around the line K. Said area is conceivable as a cone that has vertex in the origin of the line K. According to the direction pointed by the line K, the area 250 is transmitted as a time-variant electronic image by the electronic server computer 110 towards the user interface remote electronic device 140 of the user 300.

In detail, the user interface remote electronic device 140 of the user preferably comprises a screen for visualizing the images coming at least by said electronic server computer 110 and at least one user-interface means, a button, pad, joystick or other, suitable for causing the sending of commands of selection. Said commands of selection are transmitted by user interface electronic device 100 towards the electronic server computer 110 by means of any type of known type coding and anyway preferably on a transmission channel at least partially wireless.

Alternatively or in combination, said user interface remote electronic device 140 is advantageously realized under the form of spectacles with visor or with an electronic portable device of a smartphone type provided with a screen for visualizing said tridimensional virtual environment.

In a preferred and non-limiting embodiment of the present invention, said electronic portable device of a smartphone type can be integrated in an helmet or head-wearable support. This advantageously allows for having hand-free applications.

The user interface remote electronic device 140, according to the present invention, can be a device provided with either a single body or more separate bodies. The user interface remote electronic device 140 comprises anyway at least one sensor of orientation and/or of spatial position capable of causing the sending of commands of zenithal and/or azimuthal rotation towards the electronic server computer 110 in real time and according to the motion of a part of the body of the user 300.

In a preferred and non-limiting embodiment, said user interface remote electronic device 140 can be a device with substantially helmet-shaped form, and more in general assumes form of a wearable device on the head of a user 300 so that its own screen is arranged in front of the eyes of the user itself. More preferably, even though not necessarily the screen shall have such a size to occupy the substantial entirety of the area of vision of the user 300, so as to ensure advantageously greater immersion in the augmented reality.

Alternatively, said user interface remote electronic device 140 can be a spectacle with integrated display, or a cellular phone, or an electronic device susceptible of creating an holographic image of said tridimensional virtual environment.

For obtaining, the user interface remote electronic device 140 transmits of the data of adaptation of the observation direction of the line K in real time with the motion detected by sensor of zenithal and/or azimuthal orientation towards the electronic server computer 110 and as well in real time with the motion of the user 300 said user interface remote electronic device 140 receives by said electronic server computer 110 an electric signal of feedback that preferably causes the adaptation of the image represented on the screen of the user interface remote electronic device 140 according to the motion detected by the sensor.

Resuming therefore, in this case, the user interface remote electronic device 140 could have sensors of a known type suitable for allowing the inclination and the rotation of the head, translate it in a set of electric signals to be transmitted in substantially real time towards the electronic server computer 110.

As in fact is shown in FIG. 1, the user 300 in the real life moves in a tridimensional environment and can be thought that this its motion shall be generated starting from a third triad of axes X″,Y″,Z″ centered on the user 300 itself.

Though the system 100 of the present invention, therefore, a motion of rotation zenithal and azimuthal of the head of the user 300 respective to the third triad of axes X″,Y″,Z″ is equally translated in a rotation zenithal and azimuthal of the line K respective to the second triad of axes X′,Y′,Z′.

The user interface remote electronic device 140 can furthermore have of the accelerometric sensors suitable for detecting not only a zenithal and azimuthal rotation of the user 300 respective to the third triad of axes X″,Y″,Z″ but also a true and actual motion of the user, that is a motion in the space of the third triad of axes X″,Y″,Z″ that translates in real time—though the aforementioned transmission of the set of electric signals towards and from the electronic server computer 110, in a motion of the second triad of axes X′,Y′Z′ respective to the first triad of axes X,Y,Z.

FIG. 4 illustrates in detail the behavior of the system object of the present invention when the user 300, though the user interface remote electronic device 140 selects an object 210, 220 inside the tridimensional virtual space 200.

In detail, with the motion of the head of the user 300, rotates accordingly also the line K, adapting the direction of pointing of the virtual subject (block 1000).

Then, the user when has detected the object 220 with adaptable parameters of interest (for example a product of a virtual mall), the selects by means of the of user interface means on its own user interface remote electronic device 140 (block 1001). Alternatively or in combination, is can be provided that the selection performed by the user is performed though user-interface means connected with the remote electronic device by means of a cabled or wireless connection, according to any known type technique.

This selection translates in an adaptation command of the parameter on the object 220, command that is transmitted by the user interface remote electronic device 140 of the user 300 towards the electronic server computer 110, and said electronic server computer 110, when is said adaptation command of the parameter is received, since it already knows which object 220 is pointed, loads from the memory the pointed object 220 by the line K (block 1003) and adapts thereto the parameter to be adapted, performing then an update of the status of the object 220 with the adapted parameter in its memory 120. This all takes place preferably in real time.

The adaptation of the parameter to be adapted is for example a reduction of amount a warehouse of the product, meaning a purchase (block 1005).

Furthermore, is possible that first of the adaptation of the parameter on the memory 120 according to the selection performed by the user, is possible configure the system in such a way that the electronic server computer 110, following the loading from the memory of the object 220 pointed by the line K (block 1003) there is a sending of a message of request of confirmation towards the user interface remote electronic device 140 that has generated the request (block 1004), leaving once more to the user 300 the burden of using the user-interface means of its user interface remote electronic device 140 for confirming the selection, sending therefore towards said electronic server computer 110 a command of confirmation of selection of the object 220, which triggers the adaptation of the parameter to be adapted by performing then an update of the status of the object 220 with the adapted parameter in its memory 120.

In particular, in case the object is an object 220 to be used, and therefore purchased and/or rent, the parameter to be adapted can be any type of datum among a price or a residual quantity datum.

Optionally, the tridimensional virtual space 200 can be adapted according to the selection performed by the user. Therefore, the parameter to be adapted though the selection on the user interface means, can also be a parameter of appearance/disappearance type of the object 220. This happens for example in case of a purchase of a the last product in stock in a virtual mall.

Following of the transmission of an adaptation command of the status of the object, there is always the transmission of data of feedback towards the user interface remote electronic device 140.

The data of feedback correspond preferably—in case the object 220 is a product to be purchased—in a message of confirmation of introduction of said object 220 within an electronic cart of purchase.

In a further variant of operation, the sending of an adaptation command of the status of an object 220 generates the start of the reproduction of a tridimensional movie on the user interface remote electronic device 140. Said tridimensional movie is loaded in advance in the memory of the electronic server computer 110. At the moment of the sending of the adaptation command of the status, therefore the electronic server computer 110 transmits in streaming the movie towards said user interface remote electronic device 140, and the movie is reproduced on the screen of this last keeping into account in real time the zenithal and azimuthal rotation of the user 300 respective to the third triad of axes X″,Y″,Z″. In this case therefore we deal with a command suitable to cause, in feedback, a variation of the configuration of operation of the user interface remote electronic device 140, that from a device substantially transmitting data of zenithal and azimuthal rotation on the third triad of axes X″,Y″,Z″ of the user 300 in the real environment, becomes a substantially reproducing device of data streaming of a movie, wherein the representation on the screen takes place according to said rotation zenithal and azimuthal on the third triad of axes X″,Y″,Z″. advantageously, therefore, the interaction between the user 300 and the virtual mall and—more in general—the tridimensional virtual space is sensibly enhanced.

Even if in the description up to here produced it has been disclosed a tridimensional virtual space 200 wherein are only present objects, within said tridimensional virtual space is possible that there are also more separate virtual subjects.

A virtual subject, in this case, can also point other virtual subjects in such a way that the adaptation command of a status, cannot only be referred to an object 220 to which one or more parameters can be adapted, but also to a further virtual subject.

In case the user 300 though its virtual subject points through the line K to another virtual subject, at the moment of the sending of the adaptation command of the parameter, the electronic computer 110 when it receives said command, it sends a request of adaptation of the status towards another virtual subject, and therefore retransmits a command towards a second user interface remote electronic device 140.

The electronic computer 110 calculates therefore in real time the positioning of a plurality of virtual subjects in a single environment, wherein each virtual subject is provided with of a own point of vision K managed independently from that of the others and is electronically univocally associated to a respective user interface remote electronic device 140 which is provided to one of the users 300 of the system.

Advantageously, in such a way, it is possible to really recreate a virtual mall, wherein a plurality of people or users 300, virtually represented by their virtual subjects, can meet together.

In case in said tridimensional virtual space 200 meet together a plurality virtual subjects simultaneously, these can furthermore electronically communicate one with the other. The electronic communication among a plurality of virtual subjects corresponding to a same amount of real subjects, in a preferred and non-limiting embodiment can translate to a set-up of a channel of audio/video communication at least between two user interface remote electronic devices 140 of two users that have decided of reciprocally communicating by means of a command of instauration of a channel of communication audio/video performed through the own remote electronic device.

This means—supposing that the virtual environment is for example that of a supermarket—that many users can meet together in a virtual environment and start a private communication one with the other interacting virtually even being in truth in different environments one respective to the other. In other words, though the system 100 object of the present invention is for example possible to virtually meet for shopping together, even if being physically in different places and most of all not coinciding with the supermarket itself.

The electronic communication among a plurality of virtual subjects in the system 100 object of the present invention takes place advantageously by means of or an electronic chat or though the transceiving of audio/video streams.

In a first embodiment of the present invention, in case the electronic communication is a chat, a first virtual subject 230 at first points by means of the line K a second virtual subject 230. Then the user of the first virtual subject by means of the own user interface remote electronic device, provides for transmitting a command of request of activation of an electronic communication towards the electronic computer 110. This last receives said command of request of activation of said electronic communication and provides for detecting the direction pointed by the line K of the first virtual subject by electronically identifying to which virtual subject 230 the request of electronic communication is addressed. Then the electronic computer 110 transmits towards the so identified second virtual subject 230 an electronic signal of request of activation of an electronic communication with the first virtual subject 230, that at the moment of confirmation by of the second virtual subject 230, causes the adaptation of the status of operation of both the user interface remote electronic devices 140 associated to first and second virtual subject 230 for activating on the screen of these last ones an electronic chat by means of which two real users can exchange texts messages and/or images.

In a second embodiment of the present invention, in case the electronic communication is a transmission of an audio/video stream, a first virtual subject 230 at first points a second virtual subject 230 by means of the line K. Then the user of the first virtual subject by means of the own user interface remote electronic device, provides for transmitting a command of request of activation of an electronic communication towards the electronic computer 110. This last receives said command of request of activation of said electronic communication and provides for detecting the direction pointed by the line K of the first virtual subject identifying electronically to which virtual subject 230 the request of electronic communication is addressed. Then the electronic computer 110 transmits towards the so identified second virtual subject 230 an electronic signal of request of activation of an electronic communication with the first virtual subject 230, that at the moment of confirmation by of the second virtual subject 230, causes the adaptation of the status of operation of both the user interface remote electronic devices 140 associated to the first and second virtual subject 230 for activating a transmission of a stream audio and/or video streaming of communication among the users 300 associated to the first and to the second virtual subject 230.

It shall be noted that according to the present invention, for streaming it is meant a stream of data generated starting by sensors and transducers arranged on the user interface remote electronic device 140 that are transmitted substantially in real time between the two or more user interface remote electronic devices 140 by passing through the electronic computer 110.

Preferably, in the system object of the present invention, the transmission of the audio and/or video streaming is performed also among a plurality of subjects simultaneously. This technically implies that a virtual subject 230 can at first point by means of the line K a second virtual subject 230 and then to a third virtual subject 230, and a fourth one, thereby creating a sequence of virtual subjects addressees of simultaneous an electronic communication audio/video.

In case the electronic computer receives said command of request of activation of said electronic communication, provides for detecting the direction pointed by the line K of the first virtual subject identifying electronically to which virtual subject 230 is addressed the request of electronic communication. Then the electronic computer 110 transmits towards the second virtual subject 230, towards the third, fourth, . . . virtual subject so identified an electronic signal of request of activation of an electronic communication with the first virtual subject 230, that at the moment of confirmation by the respective subjects, cause the adaptation of the status of operation of all the user interface remote electronic devices 140 associated to the first, second virtual subject 230, . . . for activating a transmission of an audio and/or video streaming of communication among the users 300 associated at first to the virtual subjects 230 involved in the request.

In a further preferred and non-limiting embodiment, the tridimensional virtual space 200 is represented in a form of a cockpit of a vehicle. Inside of said vehicle there are objects 220 whose status can be adapted, and said objects are portions of said cockpit which are optionally customizable. In detail, a non-exhaustive list of objects 220 comprises: steering wheels with form and/or adaptable material, colors and finishes and/or upholstery material of the vehicle and/or of seats thereof, presence and/or absence of components like navigators, openable roofs, etc. For each of said objects 220 the adaptable status, stored in the memory of the electronic computer comprises one or more parameters of presence, form and color distinguished.

Said command of adaptation of the status of the object 220, in case a specific object among the plurality of objects 220 is selected, causes the loading by the memory of the electronic computer of a new status and/or show of the object 220 in the virtual environment, allowing the user of adapting in real time and with a tridimensional view completely fluid in the cockpit of the vehicle, by living a more vivid experience, when the traditional configurators of the vehicle allow only an adaptation of the optional and features of the cockpit in 2D or 3D manually rotatable, but not with a continuous adaptation of the perspective of view according to the motion of the user interface electronic device.

In a further embodiment, the tridimensional virtual environment is represented by an aircraft cockpit, an helicopter or plane. Said adaptation command of the status of the object 220 is capable of adapting one or more technical functions of the aircraft like for example and in a non-limiting extent commands of the gas, of the flap, of the gear, of the autopilot, transponder controls.

In the embodiment herein described, the system object of the present invention becomes a particular aid to the remote assistance for example of flight crew, included the pilot being in troubles. The tridimensional virtual environment can be that captured in a true aircraft, wherein the images that appear on the user interface electronic device 140 are images captured in real time by a plurality of video cameras arranged within the aircraft itself. In this last case the system object of the present invention allows advantageously of providing a true remote assistance to the pilot in case there are problems during the flight. Therefore, in this last case the system object of the present invention configures like a true and real electronic flight aid.

Clearly, in this last case, the latency in the transmission of the video streams by the plurality of video cameras towards the user interface electronic device 140 becomes of particular importance, and shall be therefore reduced as most as possible. According to the present invention, for latency it is meant the delay of transmission that there is between the time instant of the capture of the images or of the video stream by the plurality of video cameras, up to the time instant wherein said images or video stream are represented on the screen of the user interface electronic device 140.

Said latency is preferably lower than to 1 s, and further more preferably is lower than than 100 ms. This advantageously allows an actual bidirectional interface of command-response in real time, applicable also to real applications.

At the same time, the data stream protected by means of a suitable channel encoding that noise proof, particularly of a burst type, that can damage the data transmission under the form of packet. For said reason, in the last specifically described embodiment, but in general for all the embodiments described in the present description, preferably but in a non-limiting extent, the signal that is transmitted towards the user interface electronic device 140 is protected by means of FEC techniques or of interleaving.

During the transmission simultaneous of the various audio and/or video streams among the various virtual subjects, these can anyway continue to adapt the direction pointed by the line K eventually sending commands of adaptation of a status of an object as previously described.

Advantageously, therefore, though the function of transmission of the audio and/or video stream among a plurality of users, the virtual tridimensional space can become an actual and real environment of interaction among a plurality of subjects, wherein each one of them can hear and let voice be heard or images also towards other subjects, a function typical of the real environment wherein each of us can hear voices and see a plurality of people close to him and interactively cooperating. The tridimensional virtual space becomes therefore that actual area wherein it is possible to perform purchases.

Though the system herein described, the predetermined scopes are reached: obtaining a tridimensional virtual space wherein a plurality of users can perform purchases of objects, or see with more engaging way products and/or services, together with the possibility of organizing a real and actual virtual space within which construct an environment where a plurality of subjects can get involved also simultaneously. Though the system object of the present invention it is possible therefore to create a real and actual virtual mall.

To the system and method described in the present invention can be applied additions, adaptations or variants being obvious to the skilled person, without departing for this from the scope of protection provided by the annexed claims.

1. Electronic system (100) of interaction between a user (300) and a tridimensional virtual space (200), comprising means of creation of a virtual tridimensional space within which said user can move and/or move the point of vision of a virtual subject (230), means of definition and motion of a point of vision (K) of said virtual subject (200) within said virtual tridimensional space (200), and further comprising:
at least one computer or electronic device or server or computer network (110) wherein said tridimensional space (200) is created and stored;
at least one user interface electronic device (140), transceiving at least electronic data of motion of said point of vision (K) with said at least one computer or electronic device or server or computer network (110), wherein said user interface electronic device (140) comprises means of visualization of said virtual tridimensional space (140) and represents on said means of visualization of said virtual tridimensional space (140) a variation in real time of said point of vision (K);
wherein in said virtual tridimensional space (200), said computer or electronic device or server or computer network (110) stores a plurality of objects defined on a plurality of points respective to a reference system (X′, Y′,Z′) own of said virtual tridimensional space (230);
and wherein said means of definition and motion of said point of vision store on said at least one computer or electronic device or server or computer network (110) a variation or adaptation of a status of the at least one of said plurality of objects (210, 220) according to a selection or adaptation command of at least one object of said plurality of objects (210, 220) performed by said user (300) by means of said at least one user interface electronic device (140), and transmit towards said at least one user interface electronic device, an adaptation code of said status of said selected object (210, 220), wherein said adaptation code of said status causes a variation of the operation of said at least one user interface electronic device (140).

2. Electronic system according to claim 1, characterized in that said plurality of objects (210, 220) is a plurality of usable products, wherein for each purchasable product on said at least one computer or electronic device or server or computer network (110) is stored at least one adaptable datum of price, a residual quantity datum, and wherein at the moment of said selection, means of electronic counting are configured for decreasing said residual quantity datum and store a new residual quantity datum according to said selection performed by said user (300) by means of said at least one user interface electronic device (140).

3. Electronic system according to claim 1, characterized in that said plurality of objects (210, 220) is a plurality of parts of a confined environment, and wherein said status is a datum stored on said at least one computer or electronic device or server or computer network (110), comprising size data and/or of graphic appearance of said object (210, 220), and wherein said means of definition and motion of said point of vision (K), at the moment of the adaptation of said status, transmit data of adaptation of a graphic appearance of said selected object towards said at least one user interface electronic device (140).

4. Electronic system according to claim 1, characterized in that it is configured in such a way that said computer or electronic device or server or computer network (110) transmits automatically towards said user interface electronic device (140) a tridimensional movie electronically associated to said at least one selected object (210, 220), and wherein said user interface electronic device (140) reproduces in real time said tridimensional movie by adapting the point of vision within said tridimensional movie according to a datum of motion of said user interface electronic device (140) respective to a tridimensional reference system (X″, Y″, Z″) own of said user interface electronic device, and wherein said variation of operation of said at least one user interface electronic device (140) comprises a switching from the representation of said virtual tridimensional space (200) to the representation of said tridimensional movie.

5. Electronic system according to claim 1, wherein said point of vision (K) is originated by a tridimensional reference (X′, Y′, Z′) of said virtual user (230) positioned to a known distance respective to a reference system fixed (X, Y, Z) of said virtual tridimensional space (200), said fixed reference (X, Y, Z) being stored and automatically updated to each motion of said user interface electronic device (140).

6. Electronic system according to claim 1, wherein said point of vision (K) is originated from a tridimensional reference system (X′, Y′, Z′) movable within said virtual tridimensional space (200) and wherein said electronic computer or electronic computer network (110) update automatically the distance between said tridimensional movable reference system (X′, Y′, Z′) and said tridimensional reference system fixed (X, Y, Z), said movable reference being stored and automatically updated to each motion of said user interface electronic device.

7. System according to claim 1, wherein said user interface electronic device (140) comprises a plurality of sensors of motion zenithal and azimuthal, said sensors being configured for transmitting on a plurality of time intervals of motion of said point of vision (K) within said virtual tridimensional space (230).

8. System according to claim 1, characterized in that within said virtual tridimensional space (200) said computer or electronic device or server or computer network (110) calculates the motion of more virtual subjects (230) simultaneously, each one with an own point of vision (K) controlled by a respective real user provided with of a respective user interface electronic device (140) univocally electronically associated with said own virtual user.

9. System according to claim 1, characterized in that said computer or electronic device or server or computer network (110) calculates the a communication of an audio and/or video data stream among a plurality of virtual subjects (230) simultaneously.

10. Method of interaction of a user in a virtual tridimensional space (200), said method comprising:
a step of creation of a virtual tridimensional space (200) inside of a memory of a computer or electronic device or server or computer network (110),
a step of storage in said memory of at least one of a plurality of virtual subjects (230), susceptible of move and/or adapt an own point of vision (K) of said virtual tridimensional space (200);
a subsequent step of electronic assigning of each virtual subject of said plurality of virtual subjects (230) to the electronic control by of a respective user interface remote electronic device (140), wherein said user interface electronic device (140) comprises means of visualization of said virtual tridimensional space (140) and represents on said means of visualization of said virtual tridimensional space (140) a variation in real time of said point of vision (K);
a step of storage within said virtual tridimensional space (200) of a plurality of objects (210, 220) of which at least part has one adaptable electronic status through said user interface remote electronic device (140) and is stored in the memory of said computer or electronic device or server or computer network (110), and wherein an adaptation code of the electronic status of said object of said plurality of objects is transmitted by said user interface remote electronic device (140) following of a selection of an object by of said user (300) controlling the virtual subject (230) through the user interface remote electronic device (140) and causes a variation of the operation of said at least one user interface electronic device (140).

11. Method according to claim 10, characterized in that said adaptable electronic status of said at least one object of said plurality of objects (210,220) is a price, a residual quantity of products in at least one warehouse, and at the moment of said selection, means of electronic counting perform a step of decrease of a residual quantity of product within said warehouse and store a new residual quantity datum according to said selection performed by said user (300) by means of said at least one user interface remote electronic device (140).

12. Method according to claim 10, characterized in that said plurality of objects (210,220) comprises at least in part a plurality of parts of a confined environment and wherein said status is a datum stored that comprises size and/or graphic appearance data of said object (210, 220), and wherein means of definition and motion of a point of vision (K) of said object, at the moment of the adaptation of said status, transmit data of adaptation of a graphic appearance of said selected object towards said at least one user interface remote electronic device (140).

13. Method according to claim 10, characterized in that each virtual subject of said plurality of virtual subjects (140) comprises a point of vision (K) generated by a tridimensional reference(X′, Y′, Z′) of said virtual user (230) positioned to a known distance respective to a reference system fixed (X, Y, Z) of said virtual tridimensional space (200); said tridimensional reference system (X′, Y′, Z′) of said virtual user is stored and automatically updated to each motion of said user interface electronic device (140).

14. Method according to claim 13, wherein said point of vision (K) is originated from a tridimensional movable reference system within said virtual tridimensional space (200) and wherein said electronic computer or electronic computer network (110) update automatically the distance between said tridimensional fixed reference system (X, Y, Z) and said tridimensional movable reference system (X′, Y′, Z′), said tridimensional movable reference system being stored and automatically updated to each motion of said user interface electronic device.

15. Method according to claim 10, characterized in that it comprises a transmission on a plurality of time intervals, data of motion of said point of vision (K) within said virtual tridimensional space (230), said transmission taking place starting from user interface remote electronic device (140) which comprises a plurality of sensors of zenithal and azimuthal motion.

16. Method according to claim 10, characterized in that within said virtual tridimensional space (200) said computer or electronic device or server or computer network (110) calculates the motion of more virtual subjects (230) simultaneously, each one with an own point of vision (K) controlled by a respective real user provided with of a respective user interface electronic device (140) univocally electronically associated with said own virtual user.

17. Method according to claim 10, characterized in that said computer or electronic device or server or computer network (110) calculates a communication of an audio and/or video data stream among a plurality of virtual subjects (230) simultaneously.

18. Method according to claim 10, characterized in that the data transmitted towards said user interface electronic device (140) are transmitted with a low latency, lower than to 1 s.

19. Method according to claim 10, characterized in that the data transmitted towards said user interface electronic device (140) are transmitted with channel encoding for mitigating burst errors.
